(19) United States
(12) Patent Application Publication
(10) Pub. No.: US 2013/0282414 A1
(43) Pub. Date: Oct. 24, 2013

(54) IDEA CART

(71) Applicants: Daocheng Chen, Beijing (CN); Mingyu Jia, Beijing (CN); Zeming Zheng, Beijing (CN); Shouhong Zhang, Beijing (CN)

(72) Inventors: Daocheng Chen, Beijing (CN); Mingyu Jia, Beijing (CN); Zeming Zheng, Beijing (CN); Shouhong Zhang, Beijing (CN)

(73) Assignee: CA, Inc., Islandia, NY (US)

(21) Appl. No.: 13/452,046

(22) Filed: Apr. 20, 2012

(51) Int. Cl. G06Q 10/00

(52) U.S. Cl. 705/7.11

(57) ABSTRACT

Various embodiments illustrated and described herein include at least one of systems, methods, and computer program products of an idea cart. Some embodiments include receiving and storing data of new product improvement ideas associated with respective user credentials. Such embodiments may further include retrieving and providing product improvement idea data in response to requests associated with a user credential, the product improvement idea data retrieved and provided being only product improvement idea data associated with the user credential. Updates to the product improvement data may also be received. Additionally, some embodiments may include transmitting data of product improvement ideas to a particular network location in response to a submission command associated with data of a product improvement idea.

### BACKGROUND INFORMATION

Software applications, both client and web-based, as well as websites often request user or customer suggestions for improvement of the software application or website, product and service offerings, and other opportunities for betterment. Such suggestions are often requested from and provided by users through use of web or application forms or by simply sending an email to a particular email address.

### SUMMARY

Various embodiments illustrated and described herein include at least one of systems, methods, and computer program products of an idea cart.

One such embodiment includes receiving and storing data of new product improvement ideas associated with respective user credentials. Such embodiments may further include retrieving and providing product improvement idea data in response to requests associated with a user credential, the product improvement idea data retrieved and provided being only product improvement idea data associated with the user credential. Updates to the product improvement data may also be received. Additionally, some embodiments may include transmitting data of product improvement ideas to a particular network location in response to a submission command associated with data of a product improvement idea.

Another embodiment includes a computer program product, with instructions stored thereon which when and executed by a processor of a computing device, cause the computing device to perform actions. The actions in this embodiment include receiving and storing data of new product improvement ideas associated with respective user credentials. The actions further include retrieving and providing product improvement idea data in response to requests associated with a user credential. Only product improvement idea data associated with the user credential is retrieved and provided. This embodiment further includes receiving and storing product improvement idea data updates. Additionally, this embodiment includes transmitting data of product improvement ideas to a particular network location in response to a submission command associated with data of a product improvement idea.

Yet another embodiment is in the form of a system. The system includes a processor, a memory device, and a network interface device. An instruction set of a computer program product is stored on the a memory device. The instructions of the computer program product are executable by the processor to cause the system to provide a product improvement idea user interface through which data of a product improvement idea is received and presented. The instructions are further executable to receive, through the product improvement idea user interface, data representative of an idea for improvement of the computer program product and store the data representative of the idea for improvement of the computer program product on the memory device. The instructions are also executable to present a submission option, the selection of which causes data of a selected computer program product improvement idea to be transmitted via the network interface device to a network location identified within the computer program product.

### BRIEF DESCRIPTION OF THE DRAWINGS

Aspects of the present disclosure are illustrated by way of example are not limited by the accompanying figures with like references indicating like elements.

FIG. 1 is a networked system illustration, according to example embodiments.

FIG. 2 is a user interface illustration, according to an example embodiment.

FIG. 3 is a user interface illustration, according to an example embodiment.

FIG. 4 is a block flow diagram of a method, according to an example embodiment.

FIG. 5 is a block flow diagram of a method, according to an example embodiment.

FIG. 6 is a block diagram of a computing device, according to an example embodiment.

### DETAILED DESCRIPTION

Various embodiments include at least one of systems, methods, and software that allow users to enter ideas for improvement and addition of products and services of an organization. In some embodiments, details of such ideas may be entered by a user and stored without submission to the organization. The user may then retrieve the stored details of the idea and modify or add to the details and later submit the details of the idea to the organization. A user may store the details of a plurality of ideas without submitting the ideas. The ideas thereby are held in an idea cart viewable and modifiable only by the user. Subsequently, the user may choose to submit one or more of the stored ideas in the idea cart. As a result, users are able to further refine their ideas prior to submission, which is likely to result in submission of more well thought out ideas, which is likely to provide greater value to the organization.

Some such embodiments may further include mechanisms that incentivize submission of ideas through the idea cart. For example, a user may receive certain or assigned reward points or currency for one or more actions taken or performed with regard to an idea, such as submitting the idea, acceptance of the idea by the organization, implementation of the idea, other possible actions. The points or currency may be provided to the submitting user through a reward program of the organization receiving the suggestion, a reward program of another entity (i.e., an airline, a hotel, a retail entity, or other organization), a currency amount credited to a bank account of the user, issuance of a gift card, or other point or currency medium.

Details of these and other embodiments are provided in the following detailed description, reference is made to the accompanying drawings that form a part hereof, and in which is shown by way of illustration specific embodiments in which the subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter.

The following description is, therefore, not to be taken in a limited sense, and the scope of the inventive subject matter is defined by the appended claims.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

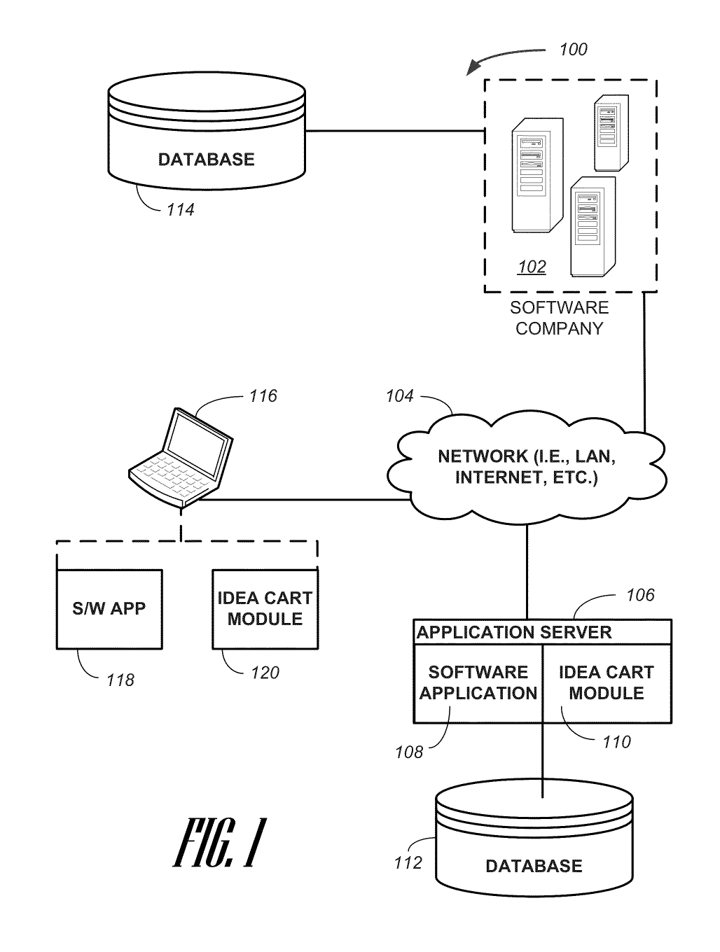

FIG. 1 is a networked system 100 illustration, according to example embodiments. The networked system 100 includes a computing environment 102 of an entity providing at least one software product, such as an application 108 that executes on an application server 106 accessible by a client computing device 116 (e.g., personal computer, smartphone, tablet computer, set top box, a computerized automobile interface device, and the like) via network 104, such as the Internet. These and other embodiments may also or alternatively, include an app or application 118 that executes on the client computing device 116. The computing environment 102 typically includes at least one computing device that executes software to receive submissions of ideas from one or more idea cart modules 110, 120 that may execute on the application server 106, the client computing device 116, or other computing device.

The idea cart modules 110, 120 may be a portion of a larger software application 108, 118 or be standalone applications or apps. The idea cart modules 110, 120 are executable on their respective computing devices to receive input from a user detailing an idea for improvement or addition of a product or service of the entity of the computing environment 102. While the entity in some embodiments is an entity providing at least one software product, this need not be the case. The entity in some embodiments may be virtually any entity type, such as a retailer, a provider of financial services, a non-profit organization, a government entity, and other entity types.

When a user enters an idea via an idea cart module 110, 120, the user may provide various types of data. Such data types may include text, selections of presented product and service options of the entity to which the respective idea pertains, attachments of computer files such as documents or images, and other data depending on the particular embodiment. The idea cart module 110, 120 upon receipt of data of the idea may then present the user with options on how to handle the data. These options may include an option to submit the data. However, the user is also presented an option to save the data without submitting the idea data.

The idea data, when saved by the user without submission, may be stored on a memory device of the client computing device 116, within a database 112 accessible to the application server 106, or other storage location. Saved idea data is typically accessible only by the user providing the input. Thus, depending on where the data is stored in the particular embodiment, security measures may be included. For example, when the data is stored in the database 112 or other resource that may be accessible by other users, permissions data may restrict access to the submitting user. In some such embodiments and others, the idea data may be encrypted utilizing an encryption key of or known to the submitting user.

In some embodiments, more than one user may be associated with a stored idea. In such embodiments, when entering or later editing the idea data, a user may associate another user identity with the idea data. That user may then access the stored idea data. In some embodiments, although more than one user may be associated with idea data of an idea, one or more of the user may have limited access to the idea data. For example, one or more users may only have read access while another user may have read, update, and delete access to the data of the idea.

Once data of an idea is stored, the submitting user, and potentially other users as discussed, may access and edit, augment, or otherwise modify the idea. The idea data may again be stored. Once the idea data is ready for submission, the idea data may then be submitted to the computing environment 102 designated for receiving the idea data. The computing environment 102 is described as being a computing environment of an entity providing at least one software product, which is merely an example of an entity that may implement such an idea cart system 100. However, the computing environment 102 need not be maintained by such an entity. Instead, the computing environment may instead be a computing environment hosted by another as a service to the entity. Thus, the computing environment 102 may be shared by several entities that have chosen to implement an idea cart solution.

The computing environment 102, upon receipt of idea data of a submitted idea will store the idea data. The idea data may be stored in a database 114, a file server, or other data storage location. The idea data is typically stored with data identifying one or more submitting users. These users may have an account with the entity. However, if the user does not have an account with the entity, the idea data will typically include user-identifying data, as may be needed for different purposes, such as obtaining further information with regard to the idea, providing a reward or other compensation to the user, and other purposes.

In some embodiments, the computing environment 102 includes at least one process to attribute a reward or other compensation to idea submitters. Rewards and compensation may be attributed to a user based on particular idea submission actions. For example, users associated with an idea submission may receive a reward or other compensation just for submitting an idea. Following the submission of an idea, the idea may be accepted or approved by the receiving entity. Upon the acceptance or approval action, users associated with the idea submission may receive the reward or compensation for the action. Other actions may result in different or additional reward or compensation. The reward and compensation may be set by rules within process or they may be input by the entity on a case-by-case or ad hoc basis.

When action is taken with regard to an idea submission or a reward or compensation is provided by the entity with regard to an idea submission, the user that submitted the idea may view one or more of the action or reward or compensation via the idea cart module 110, 120. In other embodiments, to view actions and rewards, the submitting user may instead access the data via web site or other mechanism of the entity.

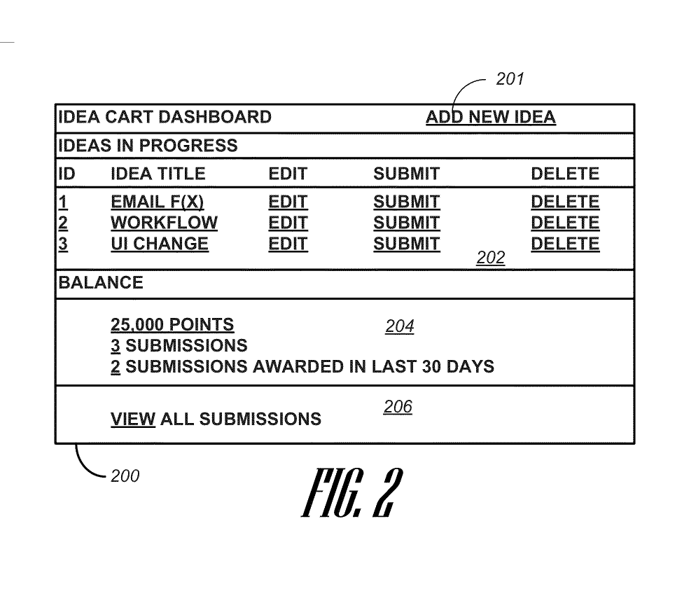

FIG. 2 is a user interface 200 illustration, according to an example embodiment. The user interface 200 is an example of a dashboard-type interface that may be provided via a web-based or app interface via the idea cart module 110, a client application interface of the idea cart module 120 that executes on a client computing device, or other application or app. The user interface 200 may provide different views of data with regard to idea cart related data. In the illustrated example embodiment, the user interface 200 provides an idea in progress portion 202, a balance portion 204, and a links portion 206. The user interface 200 may also include an control 201 that may be selected to enter a new idea.

The idea in progress portion 202 presents data representative of ideas that have been added to the idea cart but have not yet been submitted. Each idea in the idea cart has an identifier, a title, and selectable options to “EDIT,” “SUBMIT,” and “DELETE” the respective idea.

The balance portion 204, which may be included in some embodiments, may convey various types of information. Such information may include, for example, an account balance of points or currency rewarded to a user for submission of idea and possibly other actions. Such information may also include a summary of information with regard to ideas that have been submitted. Information presented within the balance portion 204, in some embodiments are selectable to view detail data underlying the information.

The links portion 206 is an area where links may be presented to view addition information with regard to idea cart submissions, either pending, submitted, approved, and the like. Other links may also be presented in the links portion 206, such as a link to help, a customer service or support personnel link, among other possible links.

The idea in progress portion 202, the balance portion 204, and links portion 206 provide examples of data that may be presented in an idea cart dashboard-type interface. Less, more, and different information may be included in various other embodiments. Some embodiments may also allow a user to customize the user interface 200 to present information of interest in a manner desired by the user.

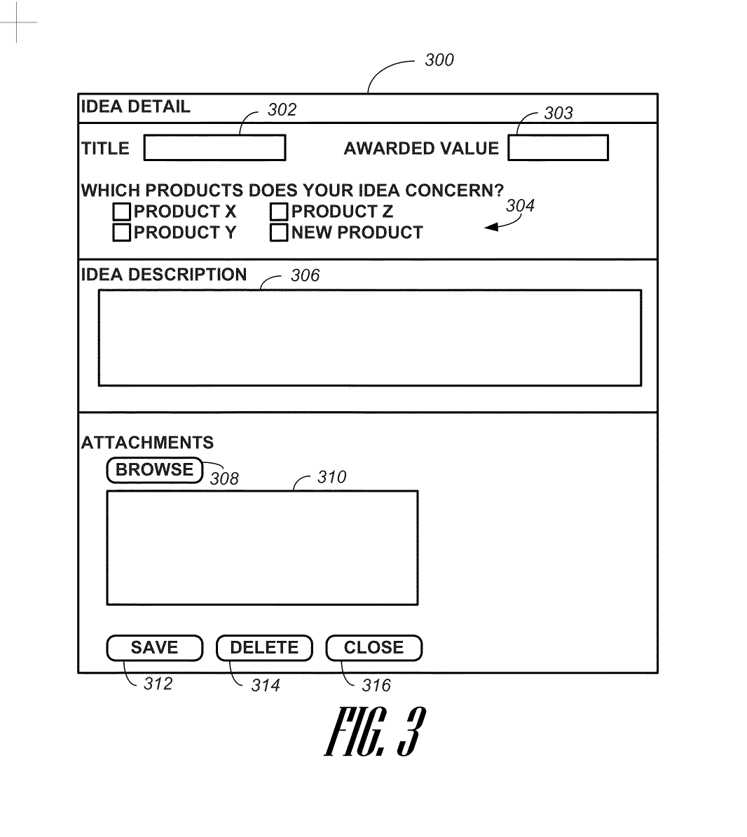

FIG. 3 is a user interface 300 illustration, according to an example embodiment. The user interface 300 is an example of a user interface that may be used to receive idea input and present details of ideas. The user interface 300 includes fields within which to receive idea data. For example, title 302 and description 306 fields. Other fields may be included in some embodiments, such as a selected listing of product or system portions 304 to which an idea pertains. Some embodiments may allow users to browse 308 stored files and attachment them to the idea. A listing of attached files 310 may therefore be included.

Different actions may be taken with an idea received into or otherwise presented by the user interface 300. The actions may include one or more of saving, deleting, and closing the user interface 300 through selection of an action respective button 312, 314, 316, menu items, or other user interface 300 controls.

Once an idea is submitted and eventually approved by a receiver of the idea, an award value may be attributed to the idea. Such an award value may be presented in an award value field 303. Thus, if a submitting user returns to view a previously submitted idea, such as through the user interface 200 of FIG. 2, the user is able to view an amount the user has been awarded.

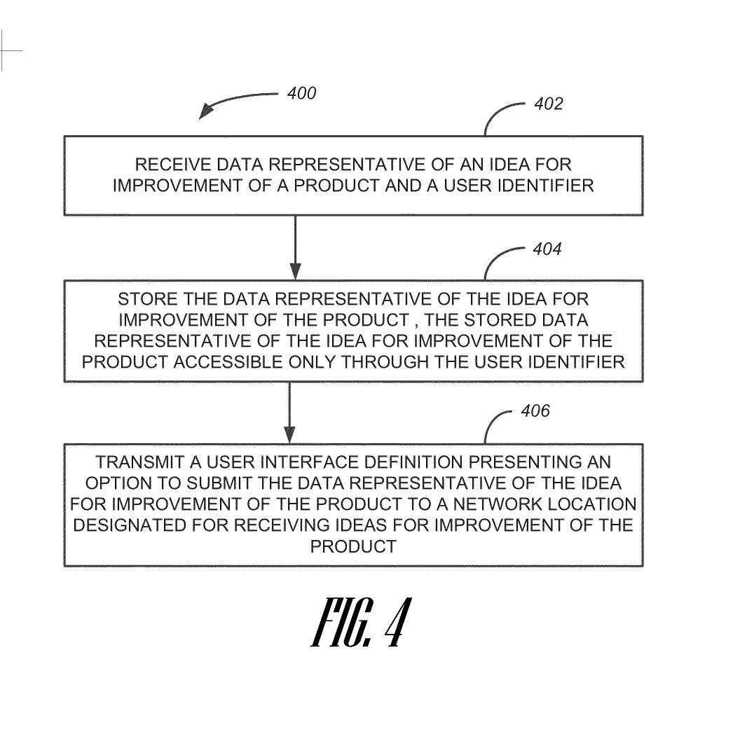

FIG. 4 is a block flow diagram of a method 400, according to an example embodiment. The method 400 is an example of a method performed to implement an idea cart, such as may be performed by a process on a networked server. Some such embodiments include receiving 402, from a computing device via a network, data representative of an idea for improvement of a product and a user identifier. The data representative of the idea for improvement of the product may then be stored 404 on a data storage device in a manner to be accessible only through the user identifier. Subsequently, the method 400 may include transmitting 406, via the network to the client computing device, a user interface definition presenting an option to submit the data representative of the idea for improvement of the product to a network location designated for receiving ideas for improvement of the product. The user definition may be encoded in a markup language renderable within a web browser application, data from which a rich internet application generates a user interface for presentation to a user, or other data from which at least a portion of a user interface definition may be encoded.

The stored 404 data representative of the idea for improvement may subsequently be edited prior being submitted to the network location designated for receiving ideas for improvement of the product. For example, some embodiments of the method 400 include receiving a request for the data representative of the idea for improvement along with the user identifier. Performance of the method 400 in such embodiments includes retrieving and transmitting the data representative of the idea for improvement to be presented within a user interface adapted to receive modifications to the data representative of the idea for improvement. Data updates may then be received and updated on the data storage device.

Some embodiments of the method 400 may also include receiving a submission command to submit the data representative of the idea for improvement of the product to the network location designated for receiving ideas for improvement of the product. In such embodiments, upon receipt of the submission command, the method 400 includes transmitting the data representative of the idea for improvement of the product to the network location designated for receiving ideas for improvement of the product. In embodiments that include a reward or incentive-type program, in response to the transmitting of the data representative of the idea for improvement, an account value may be received to attribute to an account associated with the user identifier as a reward therefore. The received account value is then attributed to the account associated with the user identifier.

Some additional embodiments of the method 400 may further include receiving data representative of a second idea for improvement of the product and the user identifier. Such embodiments may then store the data representative of the second idea for improvement of the product to be accessible only through use of the user identifier. The transmitting 406 of the user interface definition may further include transmitting a user interface definition presenting an option to submit the data representative of the second idea for improvement of the product to the network location designated for receiving ideas for improvement of the product. Additionally, this embodiment of the method 400 may then receive a submission command to submit and transmit the data representative of the idea and the second idea for improvement of the product to the network location designated for receiving ideas for improvement of the product.

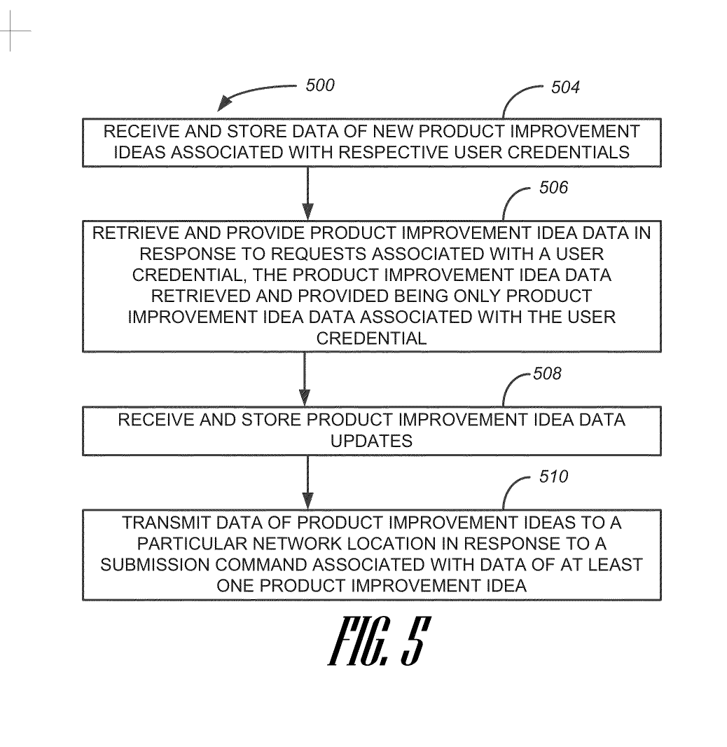

FIG. 5 is a block flow diagram of a method 500, according to an example embodiment. The method 500 is an example of another method that may be performed to implement an idea cart, such as may be performed by a process on a networked server. The method 500 includes receiving and storing 504 data of new product improvement ideas associated with respective user credentials. In response to requests associated with a user credential, the method 500 retrieves and provides 506 product improvement idea data that is associated with the user credential. Subsequently, product improvement idea data updates may be received and stored 508. Additionally, the method 500 includes transmitting 510 data of product improvement ideas to a particular network location in response to a submission command associated with data of at least one product improvement idea. The particular network location may be configuration setting, a coded network location or email address to receive such data, or other network location, depending on the particular embodiment.

Some embodiments of the method 500 further include providing a summary listing of product improvement idea data as a function of a user credential included in a received summary listing request. Such a listing may indicate, with regard to each listed product improvement idea, when the data of the respective product improvement idea has been transmitted in response to a received submission command. This listing, in some embodiments, may be provided in a manner similar to the progress portion 202 of FIG. 2. The method 500 may further include receiving a selection command with regard to a product improvement idea represented in the provided summary listing of product improvement idea data. In response to the selection command, the method 500 retrieves and provides product improvement idea data of the selected product improvement idea. The product improvement idea data is typically provided in a manner renderable within a user interface through which the product improvement data is updatable.

In some embodiments of the method 500 that are implemented with an incentive program to reward users for submitting product improvement ideas, an account balance may be maintained for each user. Upon various actions, such as submitting an idea, acceptance of a submitted idea, or other events, a command may be received from an administrator of the idea submission program to credit a user credential account. The user account is then credited. The credit may then be used for various purposes in line with the particular incentive program.

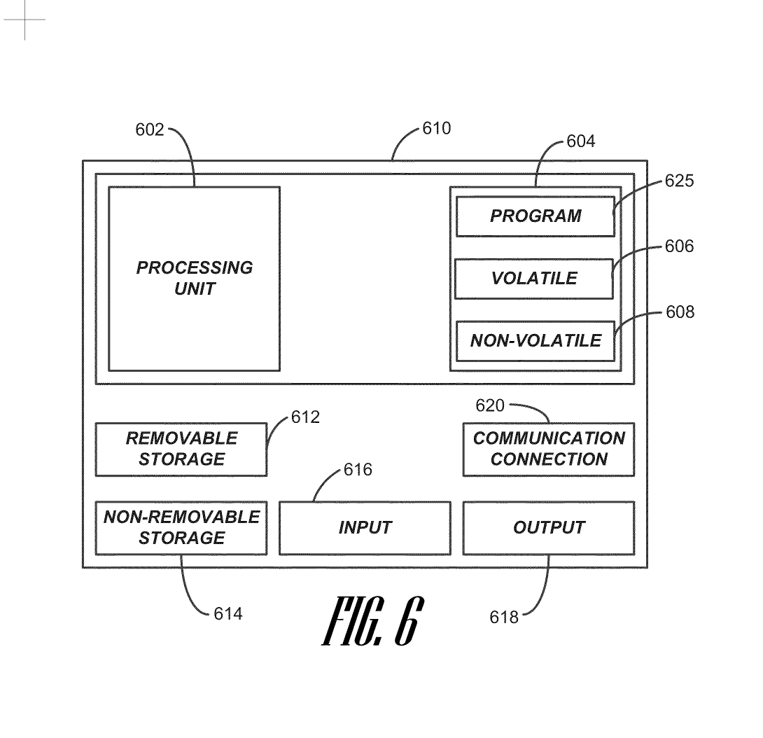

FIG. 6 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 610, may include a processing unit 602, memory 604, removable storage 612, and non-removable storage 614. Memory 604 may include volatile memory 606 and non-volatile memory 607. Computer 610 may include—or have access to a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks. The computer 610, in some embodiments, is an example of one or more of the computing devices illustrated as part of the system 100 of FIG. 1.

Computer-readable instructions stored on a computer-readable storage medium are executable by the processing unit 602 of the computer 610. A hard drive, CD-ROM, and RAM are some examples of articles including a computer-readable storage medium. For example, a computer program 625 may be stored on a computer-readable storage medium and include instructions executable by at least processing unit 602 to cause the computer 610 to perform at least a portion of one or more of the methods and other functions illustrated and described herein.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to explain the principles of the disclosure and the practical application, and to enable others of ordinary skill in the art to understand the disclosure with various modifications as are suited to the particular use contemplated.

What is claimed is:

1. A method comprising:
receiving, from a computing device via a network, data representative of an idea for improvement of a product and a user identifier;
storing, on a data storage device, the data representative of the idea for improvement of the product, the stored data representative of the idea for improvement of the product accessible only through the user identifier; and
transmitting, via the network to the client computing device, a user interface definition presenting an option to submit the data representative of the idea for improvement of the product to a network location designated for receiving ideas for improvement of the product.

2. The method of claim 1, further comprising:
receiving, via the network, data representative of a second idea for improvement of the product and the user identifier; and
storing, on the data storage device, the data representative of the second idea for improvement of the product, the stored data representative of the second idea for improvement of the product accessible only through the user identifier.

3. The method of claim 2, wherein transmitting the user interface definition further comprises transmitting a user interface definition presenting an option to submit the data representative of the second idea for improvement of the product to the network location designated for receiving ideas for improvement of the product.

4. The method of claim 3, further comprising:
receiving a submission command to submit the data representative of the idea and the second idea for improvement of the product to the network location designated for receiving ideas for improvement of the product; and
transmitting, via the network, the data representative of the idea and the second idea for improvement of the product to the network location designated for receiving ideas for improvement of the product.

5. The method of claim 1, further comprising:
receiving, via the network, a submission command to submit the data representative of the idea for improvement of the product to the network location designated for receiving ideas for improvement of the product; and
transmitting, via the network, the data representative of the idea for improvement of the product to the network location designated for receiving ideas for improvement of the product.

6. The method of claim 5, further comprising:
receiving, in response to the transmitting of the data representative of the idea for improvement, an account value to attribute to an account associated with the user identifier as a reward therefore; and
attributing the received account value to the account associated with the user identifier.

7. The method of claim 1, further comprising:
receiving a request for the data representative of the idea for improvement, the request comprising the user identifier;
retrieving, from the data storage device, and transmitting, via the network, the data representative of the idea for improvement to be presented within a user interface adapted to receive modifications to the data representative of the idea for improvement;
receiving, via the network, the data representative of the idea for improvement comprising a data modification; and
updating, on the data storage device, the stored data representative of the idea for improvement to include the data modification.

8. A computer program product comprising:
a computer readable storage medium having computer readable program code embodied therewith, the computer program code comprising:
computer readable program code configured to receive and store data of new product improvement ideas associated with respective user credentials;
computer readable program code configured to retrieve and provide product improvement idea data in response to requests associated with a user credential, the product improvement idea data retrieved and provided being only product improvement idea data associated with the user credential;
computer readable program code configured to receive and store product improvement idea data updates;
computer readable program code configured to transmit data of product improvement ideas to a particular network location in response to a submission command associated with data of a product improvement idea.

9. The computer program product of claim 8, with further computer readable program code embodied therewith, the further computer readable program code comprising:
computer readable program code configured to provide a summary listing of product improvement idea data as a function of a user credential included in a received summary listing request, the listing indicating, with regard to each listed product improvement idea, when the data of the respective product improvement idea has been transmitted in response to a received submission command;
computer readable program code configured to receive a selection command with regard to a product improvement idea represented in the provided summary listing of product improvement idea data; and
computer readable program code configured to retrieve and provide product improvement idea data of the selected product improvement idea, the product improvement idea data provided in a manner renderable within a user interface through which the product improvement data is updatable.

10. The computer program product of claim 8, wherein the computing device is accessible via a local area network and the particular network location is accessible via another network communicatively coupled to the local area network.

11. The computer program product of claim 8, wherein the computing device is a personal computer.

12. The computer program product of claim 8, with further computer readable program code embodied therewith, the further computer readable program code comprising:
computer readable program code configured to delete data of product improvement ideas in response to a delete command associated with data of a product improvement idea to be deleted.

13. The computer program product of claim 8, with further computer readable program code embodied therewith, the further computer readable program code comprising:
computer readable program code configured to maintain an account balance with regard to at least each user credential account associated with data of a product improvement ideas transmitted to the particular network location;
computer readable program code configured to receive a command to credit a user credential account in response to transmitting data of a product improvement idea to the particular network location; and
computer readable program code configured to crediting an account associated with the user credential associated with the transmitted product improvement idea data.

14. A system comprising:
a processor, a memory device, and a least one network interface device; and
an instruction set of a computer program product stored on the memory device, the instructions executable by the processor to cause the system to:
provide a product improvement idea user interface through which data of a product improvement idea is received and presented;
receive, through the product improvement idea user interface, data representative of an idea for improvement of the computer program product;
store, on the memory device, the data representative of the idea for improvement of the computer program product; and
present a submission option, the selection of which causes data of a selected computer program product improvement idea to be transmitted via the network interface device to a network location identified within the computer program product.

15. The system of claim 14, wherein the instructions of the computer program product stored on the memory device are further executable by the processor to cause the system to:
receive, through the product improvement user interface, data representative of a second idea for improvement of the computer program product; and
store, on the data storage device, the data representative of the second idea for improvement of the computer program product, the stored data representative of the second idea for improvement of the computer program product accessible only through the user identifier.

16. The system of claim 14, wherein:
the memory device comprises a database management system accessible via the network interface device, the database management system storing data on a data storage device;
the database management system storing the data representative of computer product improvement ideas received from a plurality of computer program product users;
the data representative of each computer program product improvement idea stored by the database management system in association with a user identifier of a computer program product user that submitted the data representative of the respective computer product improvement idea; and
the database management system limits access to the data of each computer program product improvement idea to a computer program product user that submitted the data of a respective computer program product improvement idea as a function of the user identifier.

17. The system of claim 14, wherein the instructions of the computer program product stored on the memory device are further executable by the processor to cause the system to:
receive, in response to the transmitting of the data representative of the idea for improvement, an account value to attribute to an account associated with the user identifier of the computer program product user as a reward for submission of the computer program product improvement idea.

18. The system of claim 14, wherein the instructions of the computer program product stored on the memory device are further executable by the processor to cause the system to:
present a computer product improvement idea data summary user interface with regard to product improvement ideas of a computer program product user.

19. The system of claim 18, wherein the computer product improvement idea data summary user interface presents management options comprising at least an option to delete data of a computer program product improvement idea, an option to edit data of an existing computer program product idea, and an option to submit data of a computer program product improvement idea.
